(19) United States
(12) Patent Application Publication
(10) Pub. No.: US 2026/0054235 A1
(43) Pub. Date: Feb. 26, 2026

(54) APPARATUS FOR MANUFACTURING ELECTRODE COMPOSITE MATERIAL

(71) Applicant: SAMSUNG SDI CO., LTD., Yongin-si (KR)

(72) Inventor: Minjun KIM, Yongin-si (KR)

(21) Appl. No.: 19/175,142

(22) Filed: Apr. 10, 2025

(30) Foreign Application Priority Data
Aug. 21, 2024 (KR) 10-2024-0111849

(51) Int. Cl. B01F 31/86; B01F 23/60; B01F 31/80; B01F 35/21; B01F 35/221

(52) U.S. Cl. CPC B01F 31/86; B01F 23/60; B01F 31/89; B01F 35/2117; B01F 35/22161

(57) ABSTRACT

The present disclosure provides an apparatus for manufacturing an electrode composite material. The apparatus may include a storage tank configured to contain a powder, a mixer connected to the storage tank by a transfer pipe, the mixer being configured to mix the powder therein, and one or more ultrasonic generators configured to transmit ultrasonic vibrations to the storage tank.

### CROSS-REFERENCE TO RELATED APPLICATION

This application claims priority under 35 U.S.C § 119 to Korean Patent Application No.10-2024-0111849, filed in the Korean Intellectual Property Office on Aug. 21, 2024, the entire contents of which are hereby incorporated by reference.

### BACKGROUND

### FIELD

Aspects of embodiments of the present disclosure relate to an apparatus for manufacturing an electrode composite material in which ultrasonic vibration is employed to separate powder from a storage tank, thereby reducing the amount of residual powder remaining during a transfer process.

### DESCRIPTION OF THE RELATED ART

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The manufacturing process for batteries includes mixing various powders, such as negative electrode materials, positive electrode materials, active materials, binders, and conductive agents, to form a slurry and coating the slurry onto a metal current collector. It is essential that respective powders be mixed in a predetermined ratio. However, during a process of transferring the powders to the mixer, some powder may remain in a storage tank, which may result in deficiencies in the required amounts for a final product. Such deficiencies may lead to issues such as reduced electrical performance of the batteries. Therefore, minimizing an amount of the residual powder in the storage tank is important.

The above information disclosed in this Background section is for enhancement of understanding of the background of the present disclosure, and therefore, it may contain information that does not constitute related (or prior) art.

### SUMMARY

Embodiments of the present disclosure provide an apparatus for manufacturing an electrode composite material, which applies ultrasonic waves to a powder storage tank to transfer all residual powder adhering to the storage tank, thereby maximizing the amount of powder incorporated into a mixture during a slurry production process.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

Aspects of embodiments provide an apparatus for manufacturing an electrode composite material including a storage tank that is configured to contain a powder, a mixer connected to the storage tank by a transfer pipe, the mixer being configured to mix the powder therein, and one or more ultrasonic generators configured to transmit ultrasonic vibrations to the storage tank.

According to one embodiment, the storage tank may include a lower part having a sloped inner surface and connected to the first transfer pipe and an upper part extending upward from a peripheral edge of the lower part.

According to one embodiment, the one or more ultrasonic generators may include one or more lower ultrasonic generators provided to the lower part and one or more upper ultrasonic generators installed provided to the upper part.

According to one embodiment, the one or more lower ultrasonic generators may include a first lower ultrasonic generator, a second lower ultrasonic generator, a third lower ultrasonic generator, and a fourth lower ultrasonic generator and the one or more upper ultrasonic generators may include a first upper ultrasonic generator, a second upper ultrasonic generator, a third upper ultrasonic generator, and a fourth upper ultrasonic generator.

According to one embodiment, the one or more lower ultrasonic generators and the one or more upper ultrasonic generators may be configured to operate alternately.

According to one embodiment, the one or more lower ultrasonic generators may be configured to operate before the one or more upper ultrasonic generators.

According to one embodiment, the one or more upper ultrasonic generators may be configured to operate before the one or more lower ultrasonic generators.

According to one embodiment, may further include a weight sensor configured to detect a weight of the powder contained in the first storage tank and a controller configured to control the one or more ultrasonic generators based on the weight of the powder detected by the weight sensor.

According to one embodiment, the controller may be configured to initiate an operation of the one or more ultrasonic generators in response to the weight of the powder detected by the weight sensor being less than or equal to a first weight.

According to one embodiment, the first storage tank may include a lower part having a sloped inner surface and connected to the first transfer pipe and an upper part extending upward from the lower part, and the one or more ultrasonic generators may include one or more lower ultrasonic generators provided to the lower part, and one or more first upper ultrasonic generators provided to the upper part.

According to one embodiment, the controller may be configured to initiate an operation of one of a group of the one or more lower ultrasonic generators and a group of the one or more upper ultrasonic generators when the weight of the powder detected by the weight sensor is less than or equal to the first weight.

According to one embodiment, the controller may be configured to alternate the operation of the one or more lower ultrasonic generators and the operation of the one or more upper ultrasonic generators.

According to one embodiment, when the weight of the powder detected by the weight sensor for a predetermined period of time is less than or equal to the first weight and is greater than a second weight that is less than the first weight, the controller may be configured to additionally operate the other group of the one or more lower ultrasonic generators and the one or more upper ultrasonic generators such that all of the one or more lower ultrasonic generators and the one or more upper ultrasonic generators are operated.

According to one embodiment, the controller may be configured to stop the operation of the one or more ultrasonic generators when the weight of the powder detected by the weight sensor is a second weight that is less than the first weight.

According to one embodiment, after all of the one or more lower ultrasonic generators and the one or more upper ultrasonic generators are in operation, the controller may be configured to stop the operation of the one or more ultrasonic generators when the weight of the powder detected by the weight sensor is the second weight.

According to one embodiment, the controller may be configured to stop the operation of the one or more ultrasonic generators when a predetermined period of time has elapsed in which the one or more lower ultrasonic generators and the one or more upper ultrasonic generators are in operation.

According to one embodiment, the one or more lower ultrasonic generators and the one or more upper ultrasonic generators may be configured to operate with different frequency bands or predetermined vibration patterns.

According to one embodiment, may further include a second storage tank connected to the first storage tank by a second transfer pipe and one or more second ultrasonic generators that are configured to transmit ultrasonic vibrations to the second storage tank.

According to one embodiment, the second storage tank may include a lower part having a sloped inner surface and connected to the second transfer pipe and an upper part extending upward from the lower part, and the one or more second ultrasonic generators may include one or more second lower ultrasonic generators provided to the lower part of the second storage tank and one or more second upper ultrasonic generators provided to the upper part of the second storage tank.

According to one embodiment, may further include a weight sensor configured to detect a weight of the powder contained in the second storage tank.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a perspective view of an apparatus for manufacturing an electrode composite material according to an embodiment of the present disclosure.

FIG. 2 is a flowchart illustrating an operational sequence of an apparatus for manufacturing an electrode composite material according to an embodiment of the present disclosure.

FIG. 3 is a cross-sectional view of the first storage tank 100 containing a powder P according to an embodiment of the present disclosure.

FIG. 4 is a cross-sectional view of the first storage tank 100 in which a powder P has been transferred and a residual powder P remains on an inner wall of the first storage tank 100 according to an embodiment of the present disclosure.

FIG. 5 is an enlarged view of a portion of an inner wall of the first storage tank 100 where a powder P remains according to an embodiment of the present disclosure.

FIG. 6 is a cross-sectional view of the first storage tank 100 in which a residual powder P is separated from an inner wall of the first storage tank 100 by ultrasonic vibration and moved to the first transfer pipe 10 according to an embodiment of the present disclosure.

FIG. 7 is a schematic view illustrating an operation of the one or more first ultrasonic generators 400 via a controller 600 in response to a case where a weight sensor 700 detects a weight of a powder P contained in the first storage tank 100 during an operation of a pump 50 (and/or a pump 52) according to one embodiment of the present disclosure.

FIG. 8 is a schematic view illustrating an operation of the one or more first ultrasonic generators 400 via the controller 600 in response to a case where the weight sensor 700 detects the weight of the powder P contained in the first storage tank 100 during an operation of the mixer 300 according to an embodiment of the present disclosure.

FIG. 9 is a schematic view illustrating an operation of a timer 30 while the controller 600 controls the one or more first ultrasonic generators 400 based on detection information from the weight sensor 700 according to an embodiment of the present disclosure.

FIG. 10 is a perspective view illustrating an apparatus for manufacturing an electrode composite material that includes a second storage tank 200 connected to the first storage tank 100 according to an embodiment of the present disclosure.

FIG. 11 is a flowchart illustrating an operational sequence of an apparatus for manufacturing an electrode composite material that includes the second storage tank 200 and one or more second ultrasonic generators 500, according to an embodiment of the present disclosure.

FIG. 12 is a flowchart illustrating an example in which the weight sensor 700 detects a first weight and a second weight, causing the first upper ultrasonic generators 420 and the first lower ultrasonic generators 410 to operate simultaneously.

FIG. 13 is a flowchart illustrating an example in which the one or more first lower ultrasonic generators 410 are activated in a case where the weight sensor 700 detects a first weight, and the one or more first upper ultrasonic generators 420 are activated in a case where the weight sensor 700 detects a second weight, according to an embodiment of the present disclosure.

FIG. 14 is a flowchart illustrating an example in which the one or more first upper ultrasonic generators 420 are activated in a case where the weight sensor 700 detects a first weight, and the one or more first lower ultrasonic generators 410 are activated in a case where the weight sensor 700 detects a second weight according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed”between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

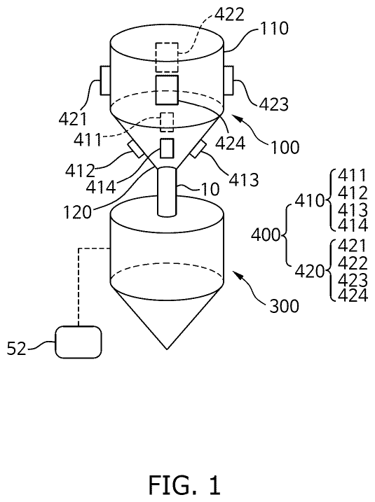

FIG. 1 is a perspective view of an apparatus for manufacturing an electrode composite material according to an embodiment of the present disclosure.

As shown in FIG. 1, the apparatus for manufacturing the electrode composite material may include a first storage tank 100 for storing a powder. A mixer 300 is connected to the first storage tank 100 by a first transfer pipe 10 and configured to mix the supplied powder. One or more first ultrasonic generators 400 may be configured to transmit ultrasonic vibrations to the first storage tank 100.

The first storage tank 100 may include a first lower part 120 having a sloped inner surface that is connected to the first transfer pipe 10 and a first upper part 110 extending upward from a peripheral edge of the first lower part 120. The first storage tank 100 may be positioned above the mixer 300. The powder supplied to the first storage tank 100 from an external source may be transferred to the mixer 300 by the weight of the powder. The powder may be moved through the opening the first lower part 120 that is connected to the first transfer pipe 10. Here, to facilitate a more active transfer of the powder, a negative pressure may be formed in an internal space of the mixer 300. This negative pressure may be created by driving a pump 52 connected to the mixer 300, with the pump functioning to lower an internal pressure of the mixer 300. Thus, the powder moving may be transferred from the first storage tank 100 to the mixer 30 through the first transfer pipe 10 0 by both the weight of the power and a pressure difference.

The mixer 300 may be operated until the mixing of powders and the like is completed. Therefore, during the operation of the mixer 300, powder may be transferred and stirred inside the mixer 300. The powder supplied to the mixer 300 may include, for example, powders such as conductive agents, binders, solvents, positive electrode materials, negative electrode materials, and active materials.

In one example of the first storage tank 100, an inner surface of the first upper part 110 may be formed as a vertical surface, while the inner surface of the first lower part 120 may be formed as the sloped surface that directs the powder toward the center of the first storage tank 100. A terminal portion of the sloped surface first lower part 120 is connected to the first transfer pipe 10 to transfer the powder to the first transfer pipe 10. In example embodiments, the first upper part 110 of the first storage tank 100 may have a cylindrical shape, and the first lower part 120 of the first storage tank 100 may have a truncated cone shape.

The powder contained within the first storage tank 100 may be pressed against and adhere to an inner wall of the first storage tank 100 by the pressure of the weight of the powder. Some of the powder adhering to the inner wall of the first storage tank 100 may remain as residual powder by not falling downward. Accordingly, in order to separate the residual powder from the inner wall of the first storage tank 100, the one or more first ultrasonic generators 400 may transmit vibrations to the first storage tank 100.

The one or more first ultrasonic generators 400 may include one or more first lower ultrasonic generators 410 installed on the first lower part 120 and one or more first upper ultrasonic generators 420 installed on the first upper part 110. The one or more first ultrasonic generators 400 may be disposed in contact with an outer surface of the first storage tank 100. The one or more first lower ultrasonic generators 410 may be attached to a sloped outer surface of the first lower part 120, and the one or more first upper ultrasonic generators 420 may be attached to a vertical outer surface of the first lower part 120. However, the number of the first lower ultrasonic generators 410 and the number of the first upper ultrasonic generators 420 are not limited, and the number of generators may be provided based on the size of the first storage tank 100.

The one or more first lower ultrasonic generators 410 may include a first-1 lower ultrasonic generator 411, a first-2 lower ultrasonic generator 412, a first-3 lower ultrasonic generator 413, and a first-4 lower ultrasonic generator 414. Similarly, the one or more first upper ultrasonic generators 420 may include a first-1 upper ultrasonic generator 421, a first-2 upper ultrasonic generator 422, a first-3 upper ultrasonic generator 423, and a first-4 upper ultrasonic generator 424. When the number of lower ultrasonic generators 410 is four and the number of upper ultrasonic generators 420 is four, the four first lower ultrasonic generators 410 may be arranged along an outer periphery of the first upper part 110 and the four first upper ultrasonic generators 420 may be arranged along an outer periphery of the first lower part 120. The ultrasonic generators 411, 412, 413, and 414 arranged on the first lower part 120 the ultrasonic generators, 421, 422, 423, and 424 arranged on the first upper part 110 may be positioned at equal intervals along the outer periphery. However, this arrangement may be selectively determined and varied by those skilled in the art.

One or more first lower ultrasonic generators 410 and one or more first upper ultrasonic generators 420 may operate alternately. The one or more first lower ultrasonic generators 410 and the one or more first upper ultrasonic generators 420 may alternately produce vibrations rather than simultaneously, and the generators may generate vibrations one or more times. For example, the first-1 upper ultrasonic generator 421, the first-2 upper ultrasonic generator 422, the first-3 upper ultrasonic generator 423, and the first-4 upper ultrasonic generator 424 may generate vibrations before the one or more first lower ultrasonic generators 410 generate vibrations. The vibrations may thereby cause the powder adhering to and remaining on the inner surface of the first upper part 110 to fall downward. Some of this powder may be transferred through the first transfer pipe 10, while the reminder of the power may accumulate at the top of the first lower part 120. Thereafter, the first-1 lower ultrasonic generator 411, the first-2 lower ultrasonic generator 412, the first-3 lower ultrasonic generator 413, and the first-4 lower ultrasonic generator 414 may then generate vibrations. In sum, the vibrations of the one or more first upper ultrasonic generators 420 and the one or more first lower ultrasonic generators 410 may be performed during the process of transferring the powder to the mixer 300 through the first transfer pipe 10.

In an alternative example, the one or more first lower ultrasonic generators 410 may operate before the one or more first upper ultrasonic generators 420. This approach may prioritize the transfer of powder that remains adhered to the first lower part 120.

In the previously described example where the vibrations are initiated alternately, even though one group of the one or more first upper ultrasonic generators 420 and a group of the one or more first lower ultrasonic generators 410 is in a vibrating state, the effect of the vibration may still be transmitted between groups.

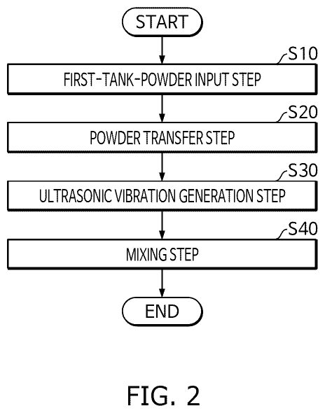

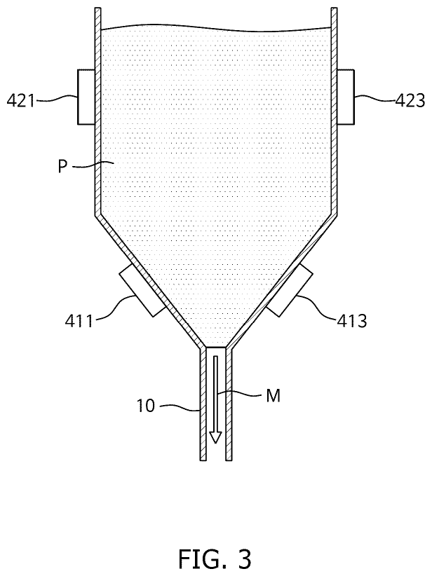

FIG. 2 is a flowchart of an operational sequence of an apparatus for manufacturing an electrode composite material according to an embodiment of the present disclosure. Hereinafter, the flowchart of FIG. 2 will be described with reference to FIGS. 3 to 6.

The apparatus for manufacturing the electrode composite material may be operated through multiple steps. In an embodiment, the method may include a first-tank-powder input step (step S10), a powder transfer step (step S20), an ultrasonic vibration generation step (step S30) (vibration of the one or more first ultrasonic generators 400), and a mixing step (step S40). These steps may represent the operational sequence of the embodiment described above with reference to FIG. 1.

In an example of the first tank-powder input step (step S10), approximately 1,000 kg of powder may be provided to the first storage tank 100. In response to a case where a predetermined condition is satisfied for the powder stored in the first storage tank 100, the powder transfer step may be carried out such that the powder is transferred to the mixer 300 through the first transfer pipe 10. The powder transfer step will be described with reference to FIG. 3, which is a cross-sectional view illustrating the first storage tank 100 containing a powder P according to an embodiment of the present disclosure. The powder P may be transferred in a transfer direction M along the first transfer pipe 10. The powder P may be transferred to the mixer 300 located below the first storage tank 100 through the first transfer pipe 10 by the weight of the powder P.

Additionally, a negative pressure may be formed in the mixer 300 the pump 52 connected to the mixer 300. This negative pressure may be formed when the powder P is transferred from the first storage tank 100 through the first transfer pipe 10 or may be formed before the powder transfer while the powder P is contained in the first storage tank 100. The pressure difference may induce the powder P to flow into the mixer 300 from the first storage tank 100 through the first transfer pipe 10. That is, the powder P may be transferred from the first storage tank 100 to the mixer 300 by both the weight of the powder P and the pressure difference resulting from the negative pressure in the mixer 300. In the above-mentioned example, most of the approximately 1,000 kg of powder P supplied to the first storage tank 100 in the first-tank-powder input step is transferred as the powder transfer step is performed. However, some of the powder P may remain in the first storage tank 100. For example, the amount of remaining powder P may be approximately 10 kg or less.

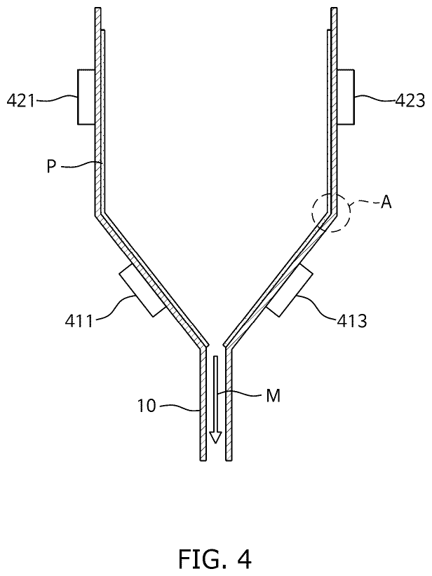

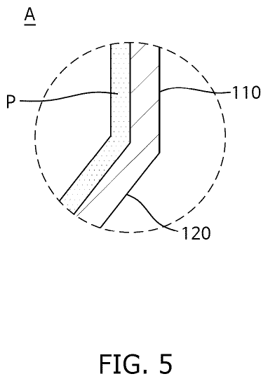

The residual powder P may be present as shown in FIG. 4. FIG. 4 is a cross-sectional view of the first storage tank 100 in which a powder P has been transferred and a residual powder P remains on an inner wall of the first storage tank 100. FIG. 5 is an enlarged view of a portion of an inner wall of the first storage tank 100 where a powder P remains.

Referring to FIGS. 4 and 5, when the amount of the powder P provided in the first storage tank 100 is approximately 1,000 kg (the actual weight may, of course, vary), most of powder P is transferred in the transfer direction M, but some of the powder P may remain adhered to the inner surfaces of the first upper part 110 and the first lower part 120.

When weight of the powder P remaining within the first storage tank 100 becomes, for example, approximately 10 kg or less, the one or more first ultrasonic generators 400 may be operated to assist in transferring the residual powder P. By operating the one or more first ultrasonic generators 400, at least a portion of the powder P of approximately 10 kg adhered to the inner surface of the first storage tank 100 may be separated from the inner surface of the first storage tank 100 and moved toward the first transfer pipe 10 by the weight of the powder.

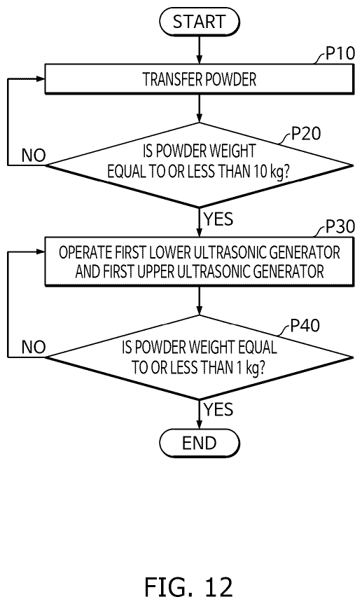

As described above, even with the application of vibration through the one or more first ultrasonic generators 400, some of the powder P may still remain within the first storage tank 100. In an example, the one or more first ultrasonic generators 400 may continue to operate until the amount of the powder P remaining in the first storage tank 100 is reduced to 1 kg or less. This process will be described in more detail below with reference to FIGS. 12 to 14.

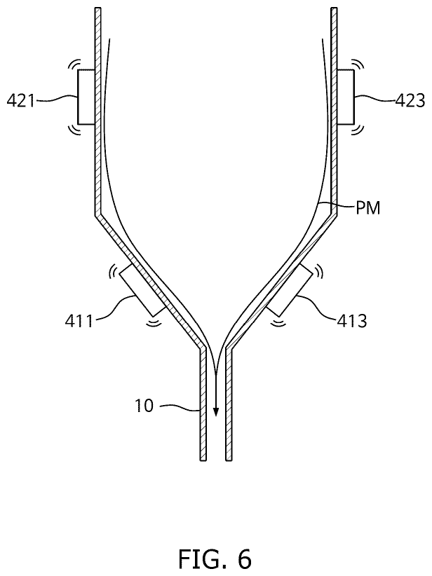

FIG. 6 is a cross-sectional view of the first storage tank 100 in which a residual powder P is separated from an inner wall of the first storage tank 100 by ultrasonic vibration and moved to the first transfer pipe 10. Specifically, FIG. 6 illustrates the transmission of vibrations from the one or more first ultrasonic generators 400 to the first storage tank 100 during the ultrasonic vibration generation step described in FIG. 2. As described above, the powder P that remains adhered to the inner surfaces of the first upper part 110 and the first lower part 120 may be separated from these inner surfaces upon the application of vibrations from the one or more first ultrasonic generators 400 to the first storage tank 100. The powder P separated from the inner surfaces of the first storage tank 100 may fall downward due to weight of the powder P and be transferred through the first transfer pipe 10 along the sloped surface of the first lower part 120.

Here, the movement of the powder P may be induced by the weight of the powder P and the pressure difference between the internal pressure of the mixer 300, formed by the pump 52, and the internal pressure of the first storage tank 100. An ultrasonic vibration generation step that transmits ultrasonic vibrations to the first storage tank 100 may be carried out to transfer the residual powder P in the first storage tank 100 to the mixer 300. Here, the ultrasonic vibrations may be transmitted simultaneously or alternately from the first upper ultrasonic generators 420 and the first lower ultrasonic generators 410. Once transferred to the mixer 300, the moved powder P undergoes a mixing step in the mixer 300 to be mixed with various powders P (e.g., active materials, conductive agents, binders, and the like) to form a slurry.

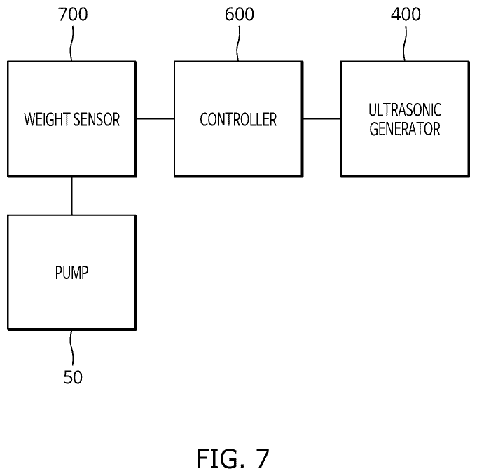

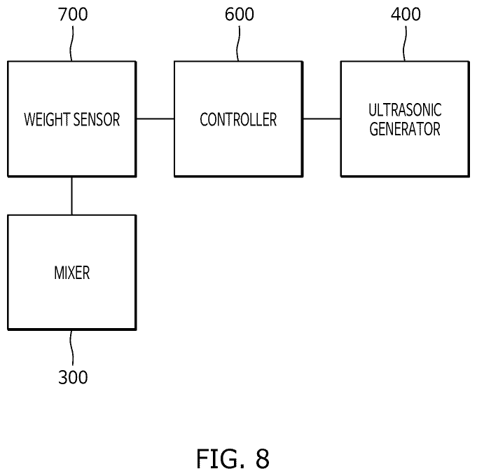

FIG. 7 is a schematic view of an operation of the one or more first ultrasonic generators 400 via a controller 600 in response to a case where a weight sensor 700 detects a weight of a powder P contained in the first storage tank 100 during an operation of a pump 50 (and/or a pump 52. FIG. 8 is a schematic view of an another operation of the one or more first ultrasonic generators 400 via the controller 600 in response to a case where the weight sensor 700 detects the weight of the powder P contained in the first storage tank 100 during an operation of the mixer 300.

Referring to FIG. 7, the apparatus may further include the weight sensor 700 that detects the weight of the powder P contained in the first storage tank 100 and the controller 600 configured to control the one or more first ultrasonic generators 400 based on the weight of the powder P detected by the weight sensor 700.

The weight sensor 700 may detect the weight of the powder P in the first storage tank 100 and transmit the detected weight of the powder P to the controller 600. Specifically, the weight sensor 700 may detect and transmit the weight of the powder P to the controller 600 while the pump 52 forms a negative pressure in the internal space of the mixer 300 and as the powder P is transferred from the first storage tank 100. That is, during the transfer of the powder P from the first storage tank 100 to the mixer 300, the weight of the powder P detected by the weight sensor 700 may be transmitted to the controller 600. Then, based on the transmitted information for the weight of the powder P, the controller 600 may determine whether to activate the one or more first ultrasonic generators 400.

For example, in a case where the aforementioned weight of about 10 kg is defined as a first weight, the weight of the powder P detected by the weight sensor 700 may gradually decrease as the powder P is transferred through the first transfer pipe 10 to the mixer 300. In a case where the detected weight of the powder P is less than or equal to the first weight, the one or more first ultrasonic generators 400 may be activated. Here, the activation of the one or more first ultrasonic generators 400 may include either the one or more first upper ultrasonic generators 420 or the one or more first lower ultrasonic generators 410 being activated or both the one or more first upper ultrasonic generators 420 and the one or more first lower ultrasonic generators being activated simultaneously. The operation of the one or more first ultrasonic generators 400 may continue until a second weight less than the first weight is detected. This second weight might be, for instance, around 1 kg. In this manner, the controller 600 connected to the weight sensor 700 may determine whether to activate the ultrasonic generators.

Referring now to FIG. 8, the weight sensor 700 may detect the weight of the powder P in the first storage tank 100 during the operation of the mixer 300 and transmit the detected weight of the powder P to the controller 600. The weight sensor 700 may continuously detect the weight of the powder P remaining in the first storage tank 100 while the powder P is being transferred to the mixer 300. That is, as the mixer 300 receives the powder P from the first storage tank 100, the weight sensor 700 may continuously perform weight detection. For example, the weight sensor 700 may continuously detect the weight of the powder P contained in the first storage tank 100 and provide weight information to the controller 600 even as the powder P is being transferred to the mixer 300.

A frequency band of ultrasonic waves emitted by the one or more first ultrasonic generators 400 described with reference to FIGS. 7 and 8 may be determined based on parameters such as a particle size of the powder P, a material of the first storage tank 100, and a wall thickness of the first storage tank 100. In some embodiments, instead of transmitting ultrasonic vibrations continuously within a single frequency band over a specified period, the vibrations may be delivered in a different frequency band or according to a predefined vibration pattern. For instance, the one or more first ultrasonic generators 400 may transmit vibrations intermittently at preset intervals, such as transmitting vibrations for two seconds at one-second intervals.

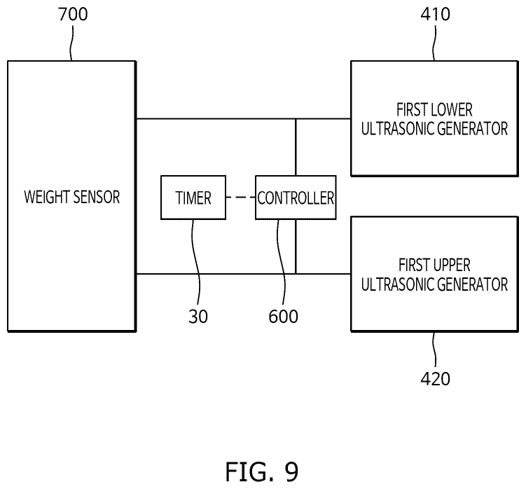

FIG. 9 is a schematic view illustrating an operation of a timer 30 while the controller 600 controls the one or more first ultrasonic generators 400 based on detection information from the weight sensor 700, according to one embodiment of the present disclosure.

Referring to FIG. 9, in response to the timer 30 indicating that all of the one or more first lower ultrasonic generators 410 and the one or more first upper ultrasonic generators 420 have operated for a predetermined time, the controller 600 may terminate the operation of the ultrasonic generators 400.

As described above, the weight sensor 700 may be operatively connected to the ultrasonic generators 400 through the controller 600. The controller 600, based on the weight information detected and transmitted from the weight sensor 700, may selectively activate the one or more first upper ultrasonic generators 420 and the one or more first lower ultrasonic generators 410 either simultaneously or in an alternating manner.

In an embodiment, the controller 600 may initiate the operation of one of a group of the one or more first lower ultrasonic generators and a group of the one or more first upper ultrasonic generators in response to a case where the weight of the powder P detected by the weight sensor 700 is equal to or less than a predetermined first weight (e.g., 10 kg). The controller 600 may cause the group of the one or more first lower ultrasonic generators and the group of the one or more first upper ultrasonic generators to operate alternately. Further, the controller 600 may additionally activate the other group in response to a case where the weight of the powder P detected by the weight sensor 700 over a predetermined period of time (e.g., 3 minutes) is less than or equal to the first weight and greater than a second weight (e.g., 1 kg) that is a smaller weight than the first weight. As such both groups of the one or more first lower ultrasonic generators and the one or more first upper ultrasonic generators all operate simultaneously.

After both groups of the one or more first lower ultrasonic generators and the one or more first upper ultrasonic generators begin to operate, the operation of the ultrasonic generators may be stopped when the weight sensor 700 detects that the weight of the powder P has reached the second weight (e.g., 1 kg) that is less than the first weight. In another example, the operation of the one or more first ultrasonic generators may be stopped when a predetermined period of time (e.g., 3 minutes) has elapsed after all of ultrasonic generators have operated.

The measurement of the time of operation of the ultrasonic generators may be performed by the timer 30. That is, the operation time of the one or more first ultrasonic generators 400 may be determined by the timer 30 connected to the controller 600. In the aforementioned example, the predetermined period of time is set to 3 minutes, but, of course, the present disclosure is not limited thereto.

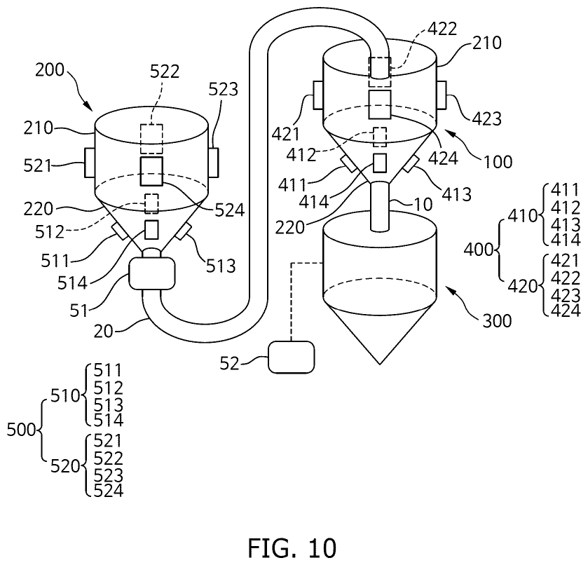

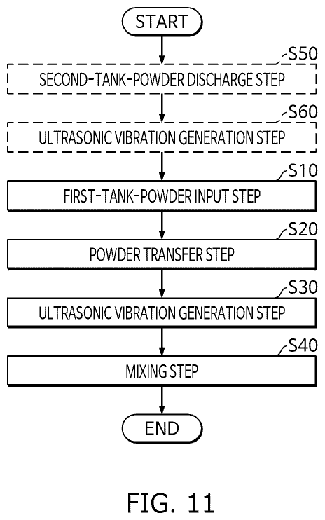

FIG. 10 is a perspective view of an apparatus for manufacturing an electrode composite material that includes a second storage tank 200 connected to the first storage tank 100 according to an embodiment of the present disclosure. FIG. 11 is flowchart of an operational sequence of an apparatus for manufacturing an electrode composite material that includes the second storage tank 200 and one or more second ultrasonic generators 500, according to one embodiment of the present disclosure.

Referring to FIG. 10, the second storage tank 200 is connected to the first storage tank 100 through a second transfer pipe 20. One or more second ultrasonic generators 500 may transmit ultrasonic vibrations to the second storage tank 200.

The second storage tank 200 may have a shape corresponding to that of the first storage tank 100, and the one or more second ultrasonic generators 500 may be configured to perform functions similar to those of the one or more first ultrasonic generators 400 described above. The second storage tank 200 may or may not necessarily be positioned above the first storage tank 100.

A second transfer pipe 20, which connects the second storage tank 200 to the first storage tank 100, may include a pump 51 within an extended section thereof. The pump 51 may generate pressure sufficient to transfer the powder P contained in the second storage tank 200 to the first storage tank 100. Unlike the first storage tank 100, which is positioned above the mixer 300 to enable the transfer of powder P by gravity, the second storage tank 200 may be positioned at the same height as the mixer 300. Thus, in order to transfer the powder P from the second storage tank 200 located at a lower position relative to the first storage tank 100 located at a higher position, the pump 51 may be used to generate the necessary pressure.

Multiple storage tanks each functioning in the manner of the second storage tank 200 may be provided. The multiple storage tanks may contain different powders P. In this case, the different powders P contained in the multiple second storage tanks 200 may be transferred to the first storage tank 100 through separate second transfer pipes 20. Examples of the different powders P contained in the multiple second storage tanks 200 include conductive materials, binders, solvents, positive electrode materials, negative electrode materials, and active materials. These powders P may then be supplied to the mixer 300 through the first storage tank 100 to prepare a slurry.

While the pump 52 connected to the mixer 300 and the pump 51 connected to the second transfer pipe 20 are similar in that each generates pressure, they differ in that the pump 52 connected to the mixer 300 forms a negative pressure within the internal space of the mixer 300, whereas the pump 51 connected to the second transfer pipe 20 generates a unidirectional transfer force.

Referring to FIG. 11, the step described with reference to FIG. 2 may further include a second tank-powder discharge step (step S50) and an ultrasonic vibration generation step (step S60) before the aforementioned steps in FIG. 2. The multiple steps may further include a step of transferring the powder P stored in the second storage tank 200 to the first storage tank 100 and a step of separating the powder P remaining in the second storage tank 200 from the inner surface of the second storage tank 200. The processes of separating powder P adhered to the inner surface of the second storage tank 200 may be the same as those described in FIGS. 3 to 6.

In the embodiment described in FIG. 10, during the second tank-powder discharge step, some of the powder P contained in the second storage tank 200 may be transferred to the first storage tank 100. During the ultrasonic vibration generation step, the remaining powder P adhered to the inner wall of the second storage tank 200 may be transferred to the first storage tank 100. Thus, once the powder P has been fully transferred to the first storage tank 100, the first tank-powder input step may be considered complete. As noted above, the transfer of all of the powder P ideally means that there is no residual powder P, but in embodiments of the present disclosure, the ultrasonic vibration may be stopped once the weight of the powder P reaches a predetermined weight, such as 1 kg or less.

The previously described relationship among the controller 600, the weight sensor 700, and the timer 30 is applicable to the embodiment described in FIGS. 10 and 11. For example, the functions of the controller 600 and the weight sensor 700 performed during the process of transferring the powder P from the first storage tank 100 to the mixer 300 may be applied in the same way to the process of transferring the powder P from the second storage tank 200 to the first storage tank 100.

FIG. 12 is a flowchart of an example in which the weight sensor 700 detects a first weight and a second weight, causing the first upper ultrasonic generators 420 and the first lower ultrasonic generators 410 to operate simultaneously. Referring to FIG. 12, a powder transfer step (step P10), a first powder weight detection step (step P20), a first upper and first lower ultrasonic generator operation step (step P30), and a second powder weight detection step (step P40) may be sequentially executed.

The powder P may be transferred from the first storage tank 100 to the mixer 300 (step P10). In the first powder weight detection step (step P20), it may be determined whether the weight of the powder P is equal to or less than a first weight. When the weight equal to or less than the first weight is detected, the operation of the one or more first ultrasonic generators 400 may be initiated. During the operation of the one or more first ultrasonic generators 400, the weight sensor 700 may continue to measure the weight of the powder P inside the first storage tank 100. When the measured weight is equal to or less than the second weight, the operation of the one or more first ultrasonic generators 400 may be stopped, and the process may be terminated. However, when the measured weight exceeds the second weight, the operation of the one or more first ultrasonic generators 400 may proceed. That is, the controller 600 may stop the operation of the one or more first ultrasonic generators 400 when the weight sensor 700 detects that the weight of the powder P is the second weight that is less than the first weight after all of the one or more first lower ultrasonic generators 410 and the one or more first upper ultrasonic generators 420 have operated.

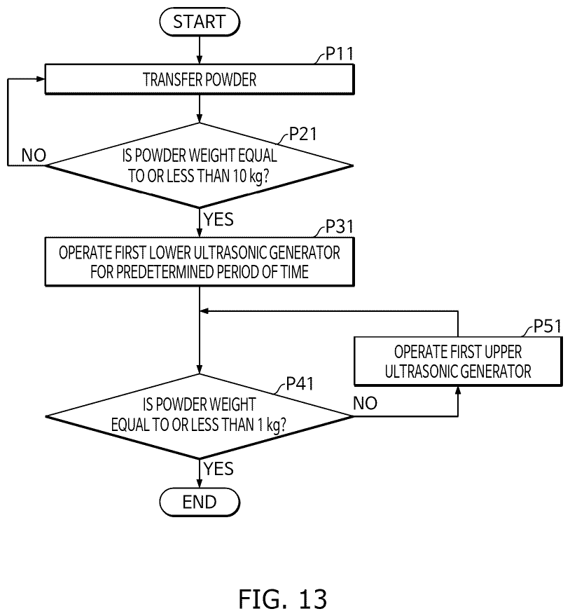

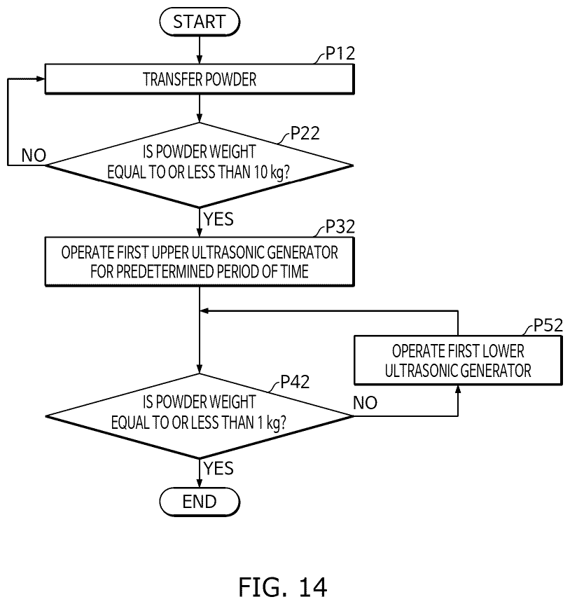

FIG. 13 is a flowchart of an example in which the one or more first lower ultrasonic generators 410 are activated when the weight sensor 700 detects a first weight, and the one or more first upper ultrasonic generators 420 are activated when the weight sensor 700 detects a second weight, according to one embodiment of the present disclosure. Further, FIG. 14 is a flowchart of an example in which the one or more first upper ultrasonic generators 420 are activated when the weight sensor 700 detects a first weight, and the one or more first lower ultrasonic generators 410 are activated when the weight sensor 700 detects a second weight, according to one embodiment of the present disclosure.

FIG. 13 illustrates an example in which the one or more first lower ultrasonic generators 410 operate before the one or more first upper ultrasonic generator 420. In contrast, FIG. 14 illustrates an example in which the one or more first upper ultrasonic generators 420 operate before the one or more first upper ultrasonic generator 420.

In a case where the weight of the powder P detected by the weight sensor 700 is less than or equal to the first weight, the controller 600 may initiate the operation of one the group of the one or more first lower ultrasonic generators 410 and the one or more first upper ultrasonic generators 420. For example, in a case where the weight of the powder P detected by the weight sensor 700 is less than or equal to the first weight, the one or more first lower ultrasonic generators 410 and the one or more first upper ultrasonic generators 420 may operate alternately.

Referring to FIG. 13, when the one or more first lower ultrasonic generators 410 has operated for a predetermined period of time (for example, 3 minutes) but the measured weight of the powder P exceeds the second weight, the one or more first upper ultrasonic generators 420 may be activated. This situation indicates that despite the vibrations generated at the first lower part 120, the weight of the remaining powder P exceeds the second weight, implying that powder P is still retained in the first upper part 110. Therefore, the one or more first upper ultrasonic generators 420 may be activated.

Referring to FIG. 14, when the one or more first upper ultrasonic generators 420 have operated for a predetermined period of time (for example, 3 minutes) but the measured weight of the powder P exceeds the second weight, the one or more first lower ultrasonic generators 410 may be activated. This situation indicates that despite the vibrations generated at the first upper part 110, the weight of the remaining powder P exceeds the second weight, implying that powder P is still retained in the first lower part 110. Therefore, the one or more first lower ultrasonic generators 410 may be activated.

In both of the aforementioned scenarios, when the weight exceeds the second weight even after operations of the one or more first lower ultrasonic generators 410 or the one or more first upper ultrasonic generators 420, both the one or more first lower ultrasonic generators 410 and the one or more first upper ultrasonic generators 420 may continue their operation until a weight less than the second weight is detected by the weight sensor 700.

As another example, in a case where the weight sensor 700 detects that the weight of the powder P is equal to or less than the first weight in FIGS. 13 and 14, the controller 600 may activate either the one or more first lower ultrasonic generators 410 or the one or more first upper ultrasonic generators 420, with the operation continuing for a predetermined period of time set by the timer 30. For instance, in a case where the timer 30 is set to three minutes, upon the detection of the weight that is equal to or less than the first weight, the controller 600 may maintain the vibration of either the one or more first lower ultrasonic generators 410 or the one or more first upper ultrasonic generators 420 for three minutes. Then, after three minutes have elapsed, based on the weight information received from the weight sensor 700, the controller 600 may operate the one or more first lower ultrasonic generators 410 and/or the one or more first upper ultrasonic generators 420 depending on whether the weight is equal to or less than the second weight or the weight exceeds the second weight. In this case, the condition for continuing operation may depend on whether the weight of the remaining powder P exceeds the second weight. For example, in a case where the one or more first lower ultrasonic generators 410 and/or the one or more first upper ultrasonic generators 420 are activated by the controller 600, the controller 600 may receive weight information continuously from the weight sensor and cause the one or more first lower ultrasonic generators 410 and/or the one or more first upper ultrasonic generators 420 to operate until the weight of the remaining powder P is detected to be equal to or less than the second weight. Also, the controller 600 may stop the operation of the one or more first lower ultrasonic generators 410 and the one or more first upper ultrasonic generators 420 after a predetermined period of time (e.g., three minutes), regardless of the weight of the remaining powder P.

Although the present disclosure has been described above with respect to embodiments thereof, the present disclosure is not limited thereto. Various modifications and variations can be made thereto by those skilled in the art within the spirit of the present disclosure.

What is claimed is:

1. An apparatus for manufacturing an electrode composite material, the apparatus comprising:
a storage tank configured to contain a powder;
a mixer connected to the storage tank by a transfer pipe, the mixer being configured to mix the powder therein; and
one or more ultrasonic generators configured to transmit ultrasonic vibrations to the storage tank.

2. The apparatus as claimed in claim 1, wherein the storage tank comprises a lower part having a sloped inner surface and connected to the first transfer pipe, and an upper part extending upward from a peripheral edge of the lower part.

3. The apparatus as claimed in claim 2, wherein the one or more ultrasonic generators comprises one or more lower ultrasonic generators provided to the lower part and one or more upper ultrasonic generators provided to the upper part.

4. The apparatus as claimed in claim 3, wherein the one or more lower ultrasonic generators comprises a first lower ultrasonic generator, a second lower ultrasonic generator, a third lower ultrasonic generator, and a fourth lower ultrasonic generator; and
wherein the one or more upper ultrasonic generators comprises a first upper ultrasonic generator, a second upper ultrasonic generator, a third upper ultrasonic generator, and a fourth upper ultrasonic generator.

5. The apparatus as claimed in claim 3, wherein the one or more lower ultrasonic generators and the one or more upper ultrasonic generators are configured to operate alternately.

6. The apparatus as claimed in claim 5, wherein the one or more lower ultrasonic generators are configured to operate before the one or more upper ultrasonic generators.

7. The apparatus as claimed in claim 5, wherein, the one or more upper ultrasonic generators are configured to operate before the one or more lower ultrasonic generators.

8. The apparatus as claimed in claim 1, further comprising:
a weight sensor configured to detect a weight of the powder contained in the first storage tank; and
a controller configured to control the one or more ultrasonic generators based on the weight of the powder detected by the weight sensor.

9. The apparatus as claimed in claim 8, wherein the controller is configured to initiate an operation of the one or more ultrasonic generators in response to the weight of the powder detected by the weight sensor being less than or equal to a first weight.

10. The apparatus as claimed in claim 9, wherein the first storage tank comprises a lower part having a sloped inner surface and connected to the first transfer pipe, and an upper part extending upward from the lower part, and
wherein the one or more ultrasonic generators comprise one or more lower ultrasonic generators provided to the lower part and one or more upper ultrasonic generators provided to the upper part.

11. The apparatus as claimed in claim 10, wherein the controller is configured to initiate an operation of one of a group of the one or more lower ultrasonic generators and a group of the one or more upper ultrasonic generators when the weight of the powder detected by the weight sensor is less than or equal to the first weight.

12. The apparatus as claimed in claim 11, wherein the controller is configured to alternate operation of the one or more lower ultrasonic generators and operation of the one or more upper ultrasonic generators.

13. The apparatus as claimed in claim 11, wherein, when the weight of the powder detected by the weight sensor for a predetermined period of time is less than or equal to the first weight and is greater than a second weight that is less than the first weight, the controller is configured to additionally operate the other group of the one or more lower ultrasonic generators and the one or more upper ultrasonic generator such that all of the one or more lower ultrasonic generators and the one or more upper ultrasonic generators are operated.

14. The apparatus as claimed in claim 9, wherein the controller is configured to stop operation of the one or more ultrasonic generators when the weight of the powder detected by the weight sensor is a second weight that is less than the first weight.

15. The apparatus as claimed in claim 13, wherein, after all of the one or more lower ultrasonic generators and the one or more upper ultrasonic generators are in operation, the controller is configured to stop the operation of the one or more ultrasonic generators when the weight of the powder detected by the weight sensor is the second weight.

16. The apparatus as claimed in claim 13, wherein the controller is configured to stop the operation of the one or more ultrasonic generators when a predetermined period of time has elapsed in which the one or more lower ultrasonic generators and the one or more upper ultrasonic generators are in operation.

17. The apparatus as claimed in claim 3, wherein the one or more lower ultrasonic generators and the one or more upper ultrasonic generators are configured to operate with different frequency bands or with different vibration patterns.

18. The apparatus as claimed in claim 1, wherein the storage tank is a first storage tank, the transfer pipe is a first transfer pipe, and the one or more ultrasonic generators are one or more first ultrasonic generators,
wherein apparatus further comprises:
a second storage tank connected to the first storage tank by a second transfer pipe; and
one or more second ultrasonic generators configured to transmit ultrasonic vibrations to the second storage tank.

19. The apparatus as claimed in claim 18, wherein the second storage tank comprises:
a lower part having a sloped inner surface and connected to the second transfer pipe; and
an upper part extending upward from the lower part, and
wherein the one or more second ultrasonic generators comprises one or more lower ultrasonic generators provided to the lower part of the second storage tank and one or more upper ultrasonic generators provided to the upper part of the second storage tank.

20. The apparatus as claimed in claim 18, further comprising a weight sensor configured to detect a weight of the powder contained in the second storage tank.
